(19) United States
(12) Patent Application Publication
(10) Pub. No.: US 2014/0013413 A1
(43) Pub. Date: Jan. 9, 2014

(54) VIDEO AND AUDIO CONFERENCE SCHEDULING

(71) Applicants: Larry E. Roher, Manhasset, NY (US); Pierre Bouchard, Oyster Bay Cove, NY (US)

(72) Inventors: Larry E. Roher, Manhasset, NY (US); Pierre Bouchard, Oyster Bay Cove, NY (US)

(73) Assignee: INTERACTIVE IDEAS LLC, Hicksville, NY (US)

(21) Appl. No.: 14/005,903

(22) PCT Filed: Mar. 16, 2012
(86) PCT No.: PCT/US12/29438

§ 371 Date: Sep. 18, 2013

Related U.S. Application Data
(60) Provisional application No. 61/454,146, filed on Mar. 18, 2011.

(51) Int. Cl. H04L 29/06

(52) U.S. Cl. CPC H04L 63/02
USPC 726/12

(57) ABSTRACT

A method and system for enabling scheduling resources including associating a first client hosted on a first computer platform using a conference scheduling module, with a second client hosted on a second computer platform. The method including initiating a client software program on a first computer on a first platform for a first client, wherein the client software program including a conference scheduling module. The method further including generating a first private cloud using the client software on the first computer communicating with a first gateway module, the first gateway module being embodied on a first gateway computer not on the first platform. Further, the method includes joining the private cloud by initiating the client software on a second computer on a second platform for a second client.

### CROSS-REFERENCE TO RELATED APPLICATION

This application claims priority under 35 U.S.C. §119(e) of U.S. Provisional Patent Application Ser. No. 61/454,146, filed Mar. 18, 2011, the disclosure of which is hereby incorporated by reference in its entirety.

### FIELD OF THE INVENTION

The present invention relates to a method and system for enabling meeting scheduling resources, and more particularly, including a method, system, and computer architecture for video and/or audio conferencing reservations and meetings.

### BACKGROUND OF THE INVENTION

Known system in the relevant art may provide video conferencing from within a company cloud where multiple departments can exist. These meetings or conferences between users exist within a single “local” (e.g., intranet) controlling entity. One disadvantage of the current conferences systems is that client video management systems within an internet service provider (ISP) cloud cannot “see” or communicate with each other, for example, due to security rules.

It would therefore be desirable to provide a meeting scheduling and conferencing system which associates and directs communication between two or more clients in a secure environment outside the clients' local computing environment.

### SUMMARY OF THE INVENTION

According to an aspect of the invention, a method for enabling meeting scheduling resources uses a computer having a processor for executing a software program embodied on a non-transitory computer readable medium, and the processor executes the steps of the software program. The method includes the steps of: associating a first client hosted on a first computer platform using a conference scheduling module, with a second client hosted on a second computer platform; and managing the first and second client association for allowing communication in a secure environment using a first gateway module on another computer platform.

In another aspect according to the invention, a method for enabling meeting scheduling resources, comprises the steps of: initiating a client software program on a first computer on a first platform for a first client, the client software program including a conference scheduling module, the client software program being embodied on a non-transient computer readable medium being executable by a processor of the first computer; initiating the client software program on a second computer on second platform for a second client; generating a first private cloud using the client software on at least the first computer communicating with a first gateway module, the first gateway module being embodied on a first gateway computer not on the first and second platforms, and being embodied on a non-transient computer readable medium being executable by a processor of the first gateway computer; joining the private cloud by using the client software program on the first and second computers.

In another aspect according to the invention, a system for enabling meeting scheduling resources, comprises a first computer platform hosting a first client on a first computer having a processor for executing a client software program embodied on a non-transitory computer readable medium. The processor executes the steps of the client software program, and the client software program includes a conference scheduling module. A second computer platform hosts a second client on a second computer having a processor for executing the client software program embodied on a non-transitory computer readable medium, wherein the processor executes the steps of the client software program. A first gateway module on a computer has a processor for executing the first gateway module embodied on a non-transitory computer readable medium. The first gateway module communicates with the first and second computers of the first and second computer platforms via a first cloud. The first gateway module is configured to associate the first client hosted on the first computer platform using the conference scheduling module, with the second client hosted on the second computer platform, for allowing communication in a secure environment.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram of a system and method for scheduling meeting resources;

FIG. 2 is a flow chart of a method according to an embodiment of the invention;

FIG. 3 is a schematic diagram and flow charts depicting selections for meetings or conference scheduling according to an embodiment of the invention;

FIG. 4 is a flow chart depicting user interaction with the conference scheduling system and software according to an embodiment of the invention;

FIG. 5 is a flow chart depicting interaction between an administrator and local client software for control and interaction with the conference scheduling system and software according to an embodiment of the invention; and

FIG. 6 is a flow chart of interaction between an administrator and a gateway module for control and interaction with the conference scheduling system and software according to an embodiment of the invention.

### DETAILED DESCRIPTION OF THE INVENTION

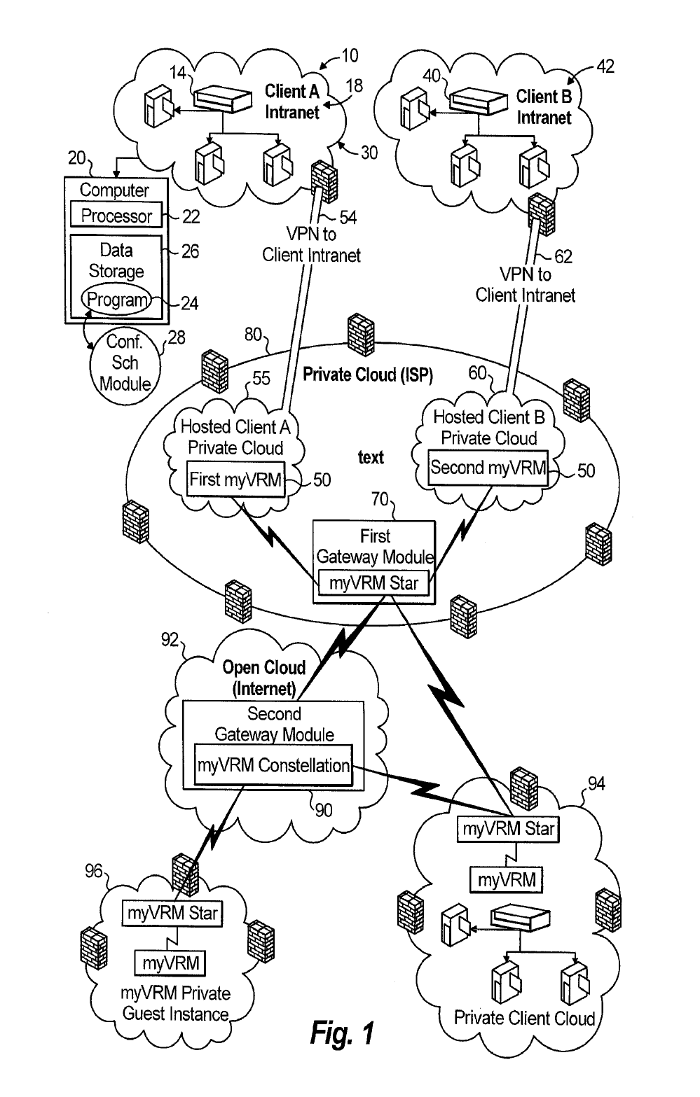

Referring to FIG. 1, a system 10 for enabling scheduling resources for meeting or conferences between multiple parties according to an embodiment of the invention includes a first computer platform 14 hosting a first client 18 on a first computer 20. The first computer has a processor 22 for executing a client software program 24 embodied on a non-transitory computer readable medium. The non-transitory computer readable medium may be embodied as a data storage device 26 on the computer 20, for example, a hard drive, flash drive or read only memory (ROM). The processor 22 is capable of executing the steps of the client software program 24. The client software program 24 includes a conference scheduling module 28. The conference scheduling module 28 may be part of a myVRM® software package, which may be accessible on-line or web based. The term, myVRM®, is a registered trademark of Interactive Ideas, LLC, and is acknowledged as a trademark herein. The first computer platform 14 generates a first intranet 30. The first computer 20 is a representation of a generic computer system of a computer platform such as the first computer platform 14, however, other processing, program storage, and software delivery methods may be used, some of which will be discussed hereinafter.

A second computer platform 40 hosts a second client 42 on a second computer having a processor for executing the client software program embodied on a non-transitory computer readable medium, wherein the processor can execute the steps of the client software program 24. The second computer is not shown for convenience as the components are generally envisioned to be the same as the first computer platform 18 for the purposes of this embodiment.

A first gateway module 70 may include a myVRM® Star™ software package and communicate with myVRM® software 50 wherein the software packages may be on a computer having a processor for executing the first gateway module embodied on a non-transitory computer readable medium. The myVRM® software package may be accessible on-line or web based. The computer for the first gateway module 70 is not shown for convenience as the components are generally envisioned to be the same as the first computer platform 18 for the purposes of this embodiment, wherein examples of such communication and computer components are discussed herein. The first gateway module 70 generates a private cloud 70 using an internet service provider (ISP). The first gateway module 70 generates a virtual private network (VPN) 54 to the first intranet 30 and a first cloud 55. The first gateway module 70 communicates with the first and second computer platforms 14, 40 via a private cloud 80 using a second cloud 60 similarly to the first cloud 55 which generates a VPN 62 to the second intranet 42. Using a second gateway module 90 which may include a myVRM® Constellation™ software package, open cloud 92 is generated, which communicates with the first gateway module 70, and generates a private client cloud 94. The private client cloud 94 enables the first gateway module 70 to associate the first client 18 hosted on the first computer platform 14 using the conference scheduling module 28, with the second client 42 hosted on the second computer platform 40. The second gateway module 90 is configured to allow scheduling of resources associated with a third client hosted on a third computer platform (not shown) to generate another private guest instance 96, wherein the third computer platform uses a conference scheduling module similar to the first computer platform 14 of the first client 18.

Further referring to FIG. 1, a method for enabling scheduling resources according to an embodiment of the invention includes associating the first client 18 hosted on the first computer platform 14 using the conference scheduling module 28, with the second client 42 hosted on the second computer platform 40.

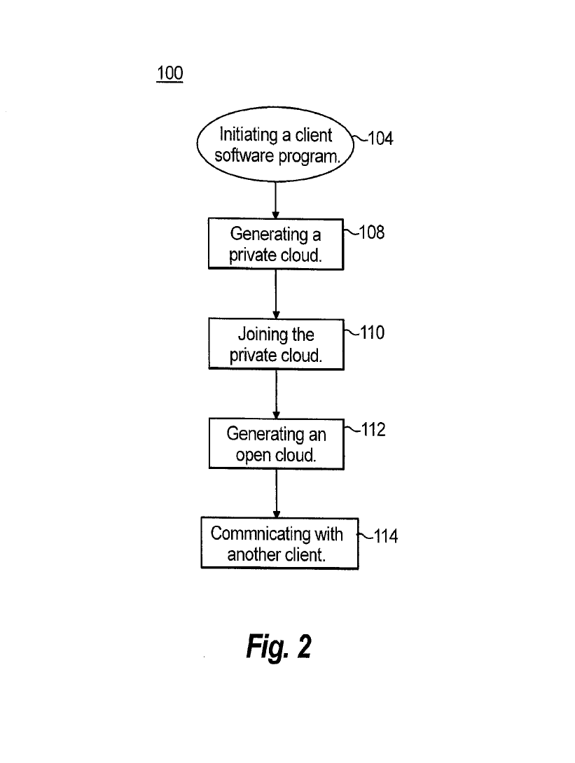

Referring to FIG. 2, a method 100, according to an embodiment of the invention, for enabling scheduling resources according to an embodiment of the invention includes the following steps. Elements referred to in the method 100 are depicted in FIG. 1. Step 104 of the method 100 includes initiating the client software program 24 on the first computer 20 on the first platform 14 for the first client 18, wherein the client software program may include the conference scheduling module 28. Step 108 includes generating the first private cloud 55 using the client software on the first computer communicating with the first gateway module 50. Step 110 includes joining the private cloud by initiating the client software on the second computer on the second platform 40 for the second client 42.

Step 114 includes generating the open cloud 92 using the client software on the first computer communicating with the second gateway module 90. The second gateway module 90 may be embodied on a second gateway computer not on the first or second platforms, and being embodied on a non transient computer readable medium for executable by a processor of the second gateway computer. The first and second gateway modules 70, 90 may be embodied on remote servers and provided via wide area network, for example, the Internet, and may be provided as a web based program. Step 114 includes the open cloud communicating with a third client and the first and second client simultaneously.

The system 10 and method 100 according to an embodiment of the present invention provides video/audio /room reservation for intra and inter-company connectivity which is scalable and secure. The first gateway module 70 software such as myVRM Star™ software package provides multi-tenant functions in scheduling conferences. The system 10 and method 100 using myVRM™ provide a scheduling solution that accomplishes scheduling for multi-facility audio or videoconferencing and meetings/events. The software of the system 10 and method 100 enables users to schedule videoconferencing, rooms and resources in a centralized environment that coordinates the functionality and organization within an organization. The myVRM™ software combines meeting room scheduling software, video bridging and videoconferencing in one integrated solution. A multi-company/multi-layer secure capability in the present disclosure may be implemented using the myVRM™ capabilities.

Using methodologies of the present disclosure, an ISP (Internet/Video Service Provider) may allow secure and reliable connection in between companies, for instance, where approvals for room selection is kept within each company, but where video (and audio) meeting may span multiple intranets clouds. In the present disclosure, a secure global video management cloud may be provided, while ensuring that necessary rules of engagements are enforced. The methodologies of the present disclosure may include functional components, e.g., referred to as myVRM Star™ and myVRM constellation™.

The myVRM Star™ software may provide: Local integration within local cloud; Global integration within local cloud; and Global integration within generic cloud (myVRM Constellation™). As explained below, a set of myVRM Stars™ will constitute a myVRM constellation™ which will control roles and entitlements across clouds respecting the specific rights of each entity.

In one example, at a high level systems view, each site/entity that will be part of the system 10 (or myVRM Star™ network) and will need to have a copy of the client scheduling module 28 of the client software program 24(e.g., myVRM™) and the first gateway module 70 (myVRM Star™ gateway software). Each first gateway module 70 (myVRM Star gateway software) has a set of rules and processes that will allow a local cloud administrator to control what/who will be granted access.

When the first gateway module 70 (e.g., myVRM Stars™) are under the same cloud (for example, an ISP (internet service provider), myVRM Star™ will allow connectivity/access to rooms in each of the intranets.

In the present disclosure, cloud refers to a computer system infrastructure that includes computing resources such as networks, servers, storages, applications, and services. Users may utilize the technology infrastructure “in the cloud”, a computing infrastructure (hardware processors and devices, operating systems, software applications) over a network. Cloud computing provides, for example, IT (information technology) services based on Internet protocols, for instance, over internet networks, and may utilize virtualized resources. Users may utilize client interfaces such as web browsers or like applications to remotely access or use services deployed on the cloud as if they were a program installed locally on the user's computer. The National Institute of Standards and Technology (NIST) defines: “Cloud computing is a model for enabling convenient, on-demand network access to a shared pool of configurable computing resources (e.g., networks, servers, storage, applications, and services) that can be rapidly provisioned and released with minimal management effort or service provider interaction. The “cloud” as shown in the drawings may include computer system or infrastructure (e.g., including one or more servers) enabled to host or run one or more applications or software, which may be accessed over one or more networks (e.g., the Internet) from another software (e.g., web browser).

### Rules Of Engagement (ROE)

In one example of a high level view of ROE, security is important to all designs involving multi-clients system, the software may be fully encrypted and communicated with only through secure Web services. ROE may be summarized as follows:

1—Each company only needs to open one https port on firewall;

2—All communications in between myVRM™, myVRM Star™ and myVRM Constellation™ are Web Service based;

3—All Web Services are encrypted and signed to ensure appropriateness;

4—Each company defines if they want to be known to the Cloud (Constellation);

5—Each room will be shareable at is both Star and Constellation level independently;

6—No company is aware by default of other myVRM Star™ members, unless these members have agreed prior;

7—Clients (myVRM Star™ members) are able to manage their room independently and ensure proper approval and validation of conference instance and internal resources;

8—Each company encryption is unique within the myVRM™ cloud (each having their own public/private key ensuring complete segregation).

The software of myVRM Star™ and Constellation™ may be considered from a technology point of view, intelligent “pass thru” , dispatcher that are able to manage relationships between each part of the overall open cloud 92 (myVRM™ cloud) in a secure manner. In one embodiment, only Constellation™ will be in the open cloud 92, and all episodes of private clouds (myStars™) are behind or border zone machines as part of companies DMZ (demilitarized zones). As only the open cloud 92 (Constellation™) is exposed, it has three level of encryption: myVRMStar™ encryption of room/company; myVRMConstellation™ encryption of Star encryption of room/company; and SSL underlying encryption supporting WS-Security (or SAML) compressed data transmission. In one aspect, use-cases will be depicted for single room as request will be compacted by Star to reduced network traffic into one block per star node.

### Example Use-Case—User Global Selection Flow

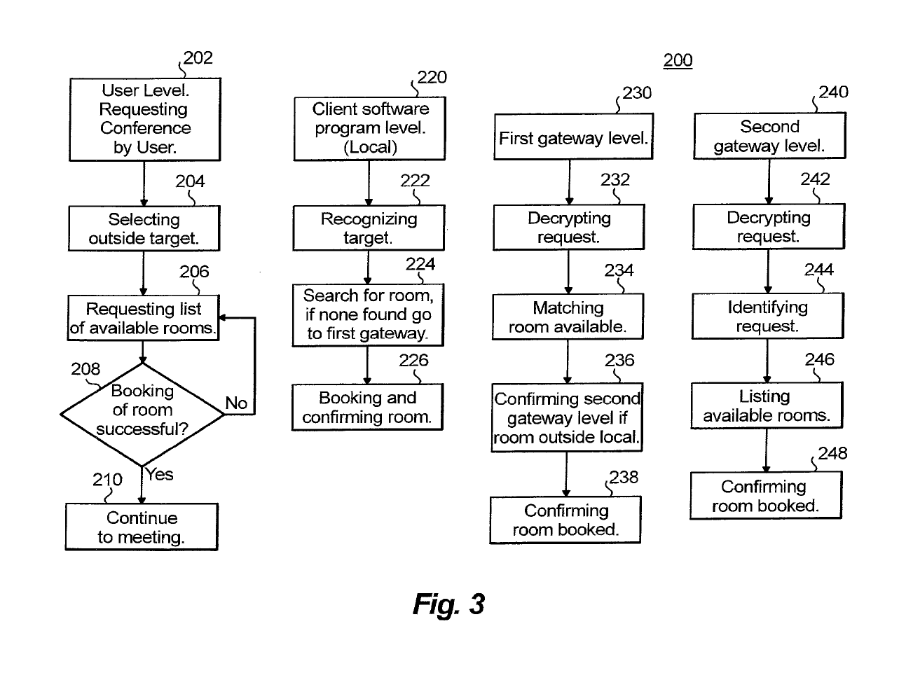

Referring to FIG. 3, a process or method 200 according to an embodiment of the invention depicts a high level global use-case for a user to select one or more outside room(s) which can be either in a local myVRMStar™ realm, or a remote myVRMStar™ realm. The process 200 schematically depicts steps in scheduling a meeting in a virtual meeting room by a user at each level of the system 10, illustrated as a user level; a client software level; a first gateway level; and a second gateway level. Step 202 of the process 200 includes a user requesting conference with an outside target, i.e., outside the organization which may include outside the company's intranet. Step 204 includes the user selecting and confirming the selection of an outside target to connect to which may include a company outside the user's company. Step 206 includes the user requesting a list of available rooms for the user's meeting. Step 208 inquires whether the booking of the room was successful, and if so the method continues to holding the meeting in step 210. If the booking of a room was not successful, the method returns to step 206.

Continuing with the process 200, level 220 is associated with a client software level of software, for example, myVRM client software. Step 222 includes the client software 28 (conference scheduling module) recognizing the target from step 204 and confirming a match. Step 224 includes searching for a meeting room, and if none are available continuing search using the first gateway module. Step 226 includes the client software booking and confirming the room requested in step 206.

Continuing with the process 200, level 230 is associated with the first gateway module, for example, myVRMStar™. Step 232 includes decrypting the request for a room based on a requester Key and returning any matching local company for further selection. Step 234 includes matching available rooms with the request for a specified time which may include passing a company ID to a local requester for follow up to confirm authenticity and room availability. Step 236 includes contacting a second gateway, for example, myVRM constellation™ if a room is not available locally. Step 238 includes confirming the booking of a room.

Further, the process 200 has a second gateway level 240, for example, myVRM Constellation™, wherein step 242 includes decrypting a request based on a requester Key and returning any matching remote company for further selection. Step 244 includes using a Request ID (which may be cached) to identify the request and proceed to the appropriate first gateway. Step 246 includes finding and listing available rooms corresponding to the company ID. Step 248 includes confirming a booked room. The client software program, the first gateway module, and the second gateway module (corresponding to: myVRM™, myVRMStar™, and myVRMConstellation™) all record the users request using a unique request ID.

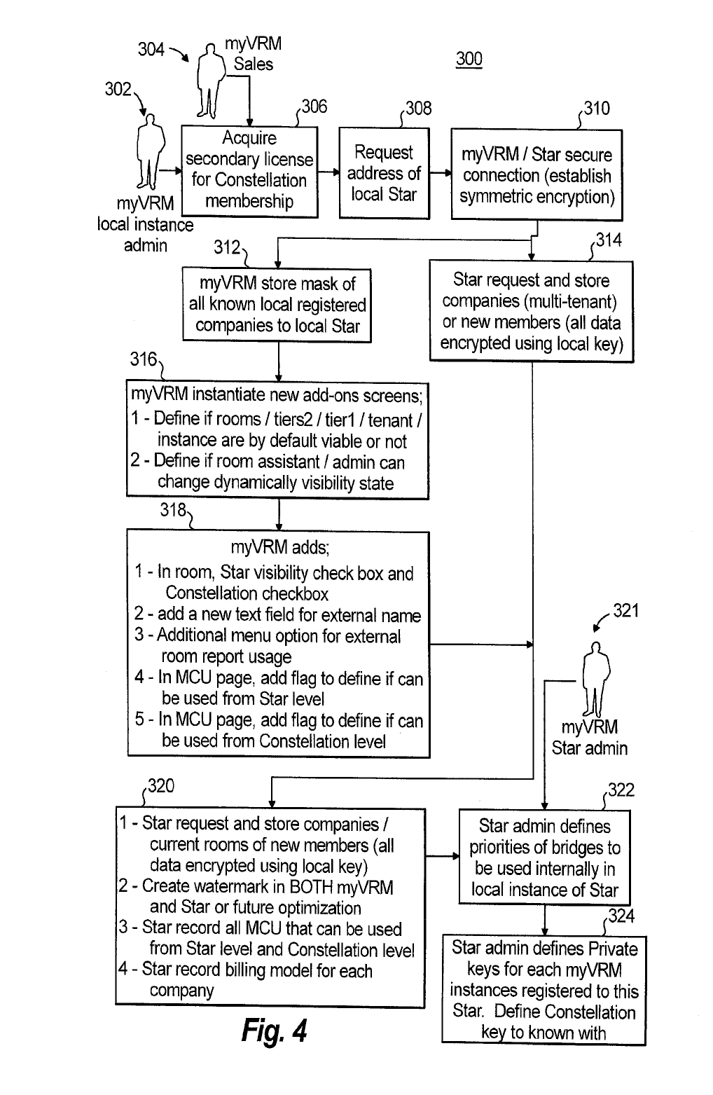

Referring to FIG. 4, a method 300 according to an embodiment of the invention details user-interaction and security rules in place for the system 10 and includes a local administrator 302 and sales representative 304. Step 306 includes acquiring a secondary license for a second gateway access, e.g., a myVRMStar Constellation™ membership. Step 308 includes requesting an address of a first gateway module, e.g., a local myVRM Star™. Step 310 includes securing a connection using the first gateway module 70, which may include establishing symmetric encryption using myVRM Start™. Step 312 includes the first gateway module 70 storing a mask of known local registered companies to the client software program, e.g., myVRM™. Step 314 includes the first gateway requesting and storing companies (which may be multi-tenant) of new members. The stored data may be encrypted using a local key. Step 316 includes the client software program 24 (e.g., myVRM™) initiating new add on screens which include: 1. Defining if rooms.tiers2/tier1/tenant/instance are by default visible or not; and defining if room assistant/admin can change dynamically visible state. Step 318 includes client software program 24 add ons including: 1. In room, visibility check box and second gateway module check box’ 2. Add a new text field for external name; 3. Additional menu option for external room report usage; 4. In MCU (multi-point control unit) page, add flag to define if can be used from first gateway module level; and 5. In MCU page, add flag to define if can be used from a second gateway module level. Step 320 includes the first gateway module generating: 1. A first gateway module request to store companies and current rooms of new members, which may be data encrypted using a local key; 2. Create a watermark in both the client software and the first gateway module for future optimization; 3. The first gateway module record MCU that can be used from the first gateway module and second gateway module level; and 4. The first gateway module record billing model for each company. Step 322 includes a first gateway module administrator 321 (myStar™ admin) defining priorities of bridges to be used internally in local instances of the client software program. Step 324 includes the administrator 321 defining private keys for each of the client software program instances registered to the first gateway module; and defining the second gateway module with a key.

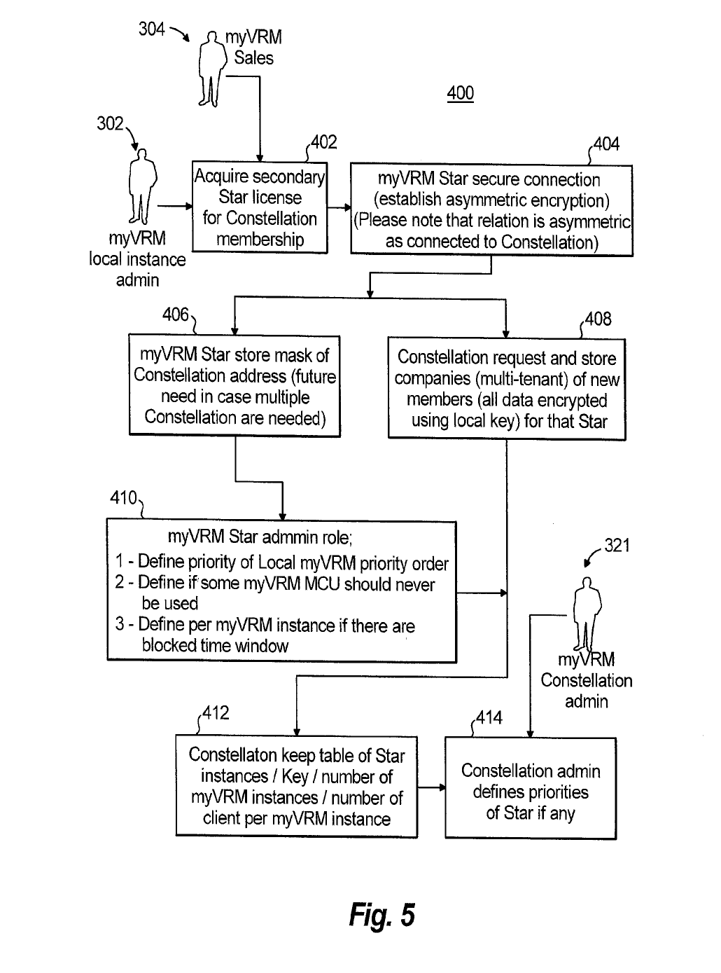

Referring to FIG. 5, a method 400 according to an embodiment of the invention includes maintaining control on a local client software program 24 (e.g., myVRM™) as far as resources allocation and availability will allow. Within the client software program 24 (e.g., myVRM™ local) and the first gateway module 70 (e.g., myVRMStar™) all data is kept within the local intranet (e.g., cloud if setup), and as such a symmetric encryption key is appropriate enhancing performance while not reducing security needs.

Further, referring to FIG. 5, the method 400 is directed to the first gateway module (e.g., myStar™) setup for cooperation in a second gateway module instance (e.g., myStar Constellation™). Step 402 includes acquiring a secondary first gateway module license for a second gateway module membership. Step 404 includes the first gateway module with a secure connection which may be established with asymmetric encryption. This connection may be asymmetric regarding the second gateway module. Step 406 includes the first gateway module storing a mask of the second gateway module address. The first gateway module may store multiple second gateway addresses. Step 408 includes the second gateway module requesting and storing companies (which have multiple tenants) of new members. The data may be encrypted using a local Key. Step 410 includes the first gateway module having an administrative role including: 1. defining priority of local client software in priority order; 2. defining if some client software program MCU should not be used; and 3. defining per the client software program if there are blocked time windows. Step 412 includes the second gateway module keeping a table of first gateway modules instances, for example, Keys/numbers of client software program instances or number of clients per the number of client software instances. Step 414 includes the second gateway module administrator 321 defining priorities of the first gateway module, if any.

On the second gateway module (e.g., myVRMConstellation™) side of the system 10, significant automation can be implemented. However, an administrator 302 may select to not participate in the second gateway module, while still having the advantages of connection to a local client software program. The administrator 302 may allow interconnection between multiple local copies of the client software program 24. This paradigm proves powerful for ISP and large international companies that can have a private cloud and do not wish to participate in a second gateway module (such as a World Constellation™ program), but would rather unite multiple IBU (Independent Business Unit each having many divisions already defined as Tenants in the client software program setup).

### Client Software Setup and Verification

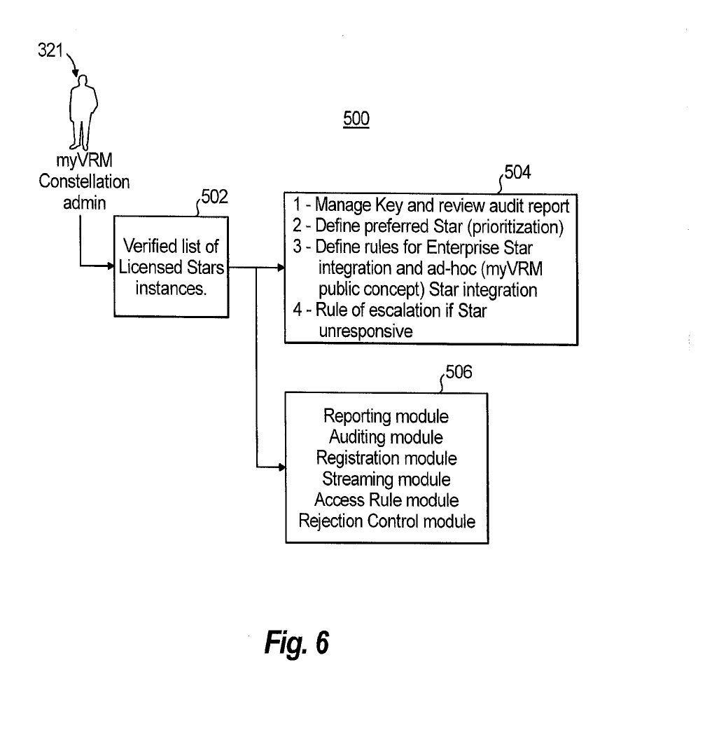

Referring to FIG. 6, a method 500 for client software setup according to an embodiment of the invention includes the client software administrator 321. Step 502 includes verifying a list of licensed instances of client software. Step 504 includes: 1. managing a Key and reviewing an audit report; 2. defining a preferred client software, that is, prioritizing multiple instances of client software; 3. defining rules for the first gateway module integration and ad-hoc first gateway integration; and 4. generating rules of escalation if the client software is unresponsive. Step 506 includes selecting one or more of multiple modules, including: a reporting module; auditing module; registration module; streaming module; access rule module; and a rejection control module.

The second gateway module (e.g., myVRM Constellation™) is accessible to client software 24 users. The second gateway module can manage intra-cloud communication, such as the clouds 55, 60, 94 shown in FIG. 1. There may be multiple second gateway modules communicating and sharing the load among them, wherein the clients see only one second gateway module. Multiple second gateway modules may exist, but once a connection (conference) is established, the second gateway behaves as if a sticky bit is set and all the elements for that conference will stay managed by the same instance of the second gateway module. The second gateway module may be used (for example as a concentrator) allowing thru client software setup to provide local client software clients with knowledge of outside parties. Once a conference is set up, the second gateway module may be used to reconnect client software to each other as gateway intermediaries or as backup processes.

### Client Software Access Modification

As in the flowcharts described above, the client software program 245 may be modified to include additional functionalities. For example, adding a check box to allow request to an “outside room”, and getting a list of available entities where room can be selected. Once selected, e.g., entities first, and room second to complete a reservation. Internally changes may include: 1. from an internal process, a request for reservation can be completed. The request is service oriented architecture (SOA) as outside parties will be accessed asynchronously and in parallel if more than one; 2. limiting user waiting time on response, a response page may be redesigned using functionality in conjunction with a program such as AJAX™, allowing a requestor to see real time progress of the request status; and 3. a corollary to the above, is that the client software may act as a hub and spoke, while the client software may act as a Hub.

In another example, new Rules Of Engagements may be defined as: 1.Whether a requestor has to wait for all rooms to send an email to invitees; 2. Whether a requestor considers a request if all internals but one external room is accepted; and 3.Whether approval of external weigh as equally as approval on internal resources.

Error recovery processing may function in a multi-level multi-threaded processing environment. Discovery of errors, and recovery of data may be implemented from the client software program.

### Technical Design

Element in technical design may also include: 1. database (DB) level for client software, the first gateway module, and the second gateway module; 2. data warehouse (DW) for the client software, and the first gateway module for auditing needs; and 3. NET (or another framework for operating system) management for the client software extension or another framework for an operating system; 4. NET (or another framework for operating system) for first gateway module programming paradigm; and 5. NET (or another framework for operating system) for the second gateway module paradigm DB layer and DW layer may accept integration with other application software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions stored in a computer or machine usable or non-transitory readable storage medium, which causes the computer or machine to perform the steps of the method when executed on the computer, processor, and/or machine. A computer readable storage medium or device may include any tangible device that can store a computer code or instruction that can be read and executed by a computer or a machine. Examples of computer readable storage medium or device may include, but are not limited to, hard disk, diskette, memory devices such as random access memory (RAM), read-only memory (ROM), optical storage device, and other recording or storage media.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The computers and software described herein may operate in a networked environment using logical connections to one or more remote computers. The computers may be a server, a router, a network PC, a peer device or other common network node. The logical connections may include a local area network (LAN) or a wide area network (WAN), but may also include other networks, such as enterprise-wide computer networks, intranets and the Internet. It will be appreciated that the network connections shown are exemplary and other means of establishing a communications link between computers and software may be used.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for enabling meeting scheduling resources using a computer having a processor for executing a software program embodied on a non-transitory computer readable medium, the processor executing the steps of the software program, comprising:
associating a first client hosted on a first computer platform using a conference scheduling module, with a second client hosted on a second computer platform; and
managing the first and second client association for allowing communication in a secure environment using a first gateway module on another computer platform.

2. The method of claim 1, wherein the first gateway module allows connectivity and/or access to scheduling the resources associated with the first client.

3. The method of claim 1, wherein a second gateway module allows scheduling of resources associated with a third client hosted on another computer platform from the conference scheduling modules of the first and second clients hosted on the first and second computer platforms, respectively.

4. A method for enabling meeting scheduling resources, comprising:
initiating a client software program on a first computer on a first platform for a first client, the client software program including a conference scheduling module, the client software program being embodied on a non-transient computer readable medium being executable by a processor of the first computer;
initiating the client software program on a second computer on second platform for a second client;
generating a first private cloud using the client software on at least the first computer communicating with a first gateway module, the first gateway module being embodied on a first gateway computer not on the first and second platforms, and being embodied on a non-transient computer readable medium being executable by a processor of the first gateway computer;
joining the private cloud by using the client software program on the first and second computers.

5. The method of claim 4, further comprising:
generating an open cloud using the client software on the first computer communicating with a second gateway module, the second gateway module being embodied on a second gateway computer not on the first or second platforms, and being embodied on a non transient computer readable medium for executable by a processor of the second gateway computer, the open cloud communicating with a third client and the first and second client simultaneously.

6. A system for enabling meeting scheduling resources, comprising:
a first computer platform hosting a first client on a first computer having a processor for executing a client software program embodied on a non-transitory computer readable medium, the processor executing the steps of the client software program, the client software program including a conference scheduling module;
a second computer platform hosting a second client on a second computer having a processor for executing the client software program embodied on a non-transitory computer readable medium, the processor executing the steps of the client software program; and
a first gateway module on a computer having a processor for executing the first gateway module embodied on a non-transitory computer readable medium, the first gateway module communicating with the first and second computers of the first and second computer platforms via a first cloud, the first gateway module configured to associate the first client hosted on the first computer platform using the conference scheduling module, with the second client hosted on the second computer platform, for allowing communication in a secure environment.

7. The system of claim 6, further comprising:
a second gateway module configured to allow scheduling of resources associated with a third client hosted on a third computer platform using the conference scheduling module of the second client hosted on the first computer platform.

8. The system of claim 7, wherein the second gateway module operably allows scheduling of resources associated with a third client hosted on another computer platform from the conference scheduling module of the first and the second clients.

9. The system of claim 7, wherein the second gateway module is operable to be deployed on a third computer platform.

10. The system of claim 7, wherein the first computer platform, the second computer platform and the third computer platform are connected via the Internet using the first and the second gateway modules.

11. The system of claim 6, wherein the first gateway module operably deploys on the first platform, the first gateway module allows scheduling resources associated with the first client hosted on the first computer platform from the conference scheduling module of the second client.

12. The system of claim 6, wherein the second gateway module is operable to be deployed on the first computer platform or the second computer platform.
